(19) United States
(12) Patent Application Publication
(10) Pub. No.: US 2025/0211030 A1
(43) Pub. Date: Jun. 26, 2025

(54) SYSTEMS, APPARATUSES, AND METHODS OF MULTIPLE CHANNEL WLC POWER DELIVERY

(71) Applicant: STMICROELECTRONICS INTERNATIONAL N.V., Geneva (CH)

(72) Inventors: Tianhao XIONG, Shanghai (CN); Gang WU, Shanghai (CN)

(21) Appl. No.: 18/391,924

(22) Filed: Dec. 21, 2023

(51) Int. Cl. H02J 50/23; H01Q 5/335; H02J 50/40

(52) U.S. Cl. CPC H02J 50/23; H01Q 5/335; H02J 50/40

(57) ABSTRACT

Systems, apparatuses, and methods for multiple channel wireless charging power delivery are provided. For example, a poller device may charge multiple listener devices. A poller device may have a separate antenna interface channel and separately poller antenna for each listener device. The poller device may include a poller transmitter that may generate distinct charge signals for each antenna interface channels that may be used to generate an electromagnetic field poller antennas. Each separate poller antenna may generate a distinct electromagnetic field to power the associated listener device. Each antenna interface channel may include one or more automatic antenna tuners that may be used to dynamically and separately tune each antenna interface channel. The poller device and listener devices may use NFC links to determine which listener devices may be charged as well as the level of charging to provide.

### TECHNOLOGICAL FIELD

Example embodiments of the present disclosure relate generally to wireless power delivery, particularly to multiple-channel wireless power delivery that may be delivered through a single chip.

### BACKGROUND

Near-field communication (NFC) using wireless charging (WLC) has been adopted for charging devices (e.g., earbuds, etc.) in multiple applications. NFC utilizes a first transmitter, poller, or reader device generating an electromagnetic field to communicate with a listener device. The electromagnetic field may be transformed by the listener device into a supply voltage to power a battery of the listener device. The electromagnetic field may be generated by the poller device at a particular frequency, which may be at a carrier frequency. The listener device may back scatter or otherwise transmit a second electromagnetic field at the same or a different frequency back to the poller. For example, there may be passive or active responses by the listener device. The listener device may include a battery that may be charged. This battery of the listener device may also provide power for transmitting the second electromagnetic field to the poller device. Conventional poller devices may charge listener devices simultaneously by generating a single electromagnetic field for all of the listener devices.

An exemplary application includes wireless earbuds. In conventional NFC using WLC, a plurality of devices (e.g., earbuds) are charged simultaneously via an antenna of the poller device. The single antenna of the poller device delivers WLC to multiple devices simultaneously without regard to the characteristics or status of any one device.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to wireless power delivery, particularly to multiple-channel wireless power delivery.

In accordance with some embodiments of the present disclosure, an example apparatus for wireless charging is provided. The apparatus may comprise: a poller transmitter electrically connected to a plurality of antenna interface channels, wherein each antenna interface channel includes an output port for connection to a poller antenna of a plurality of poller antennas for wirelessly charging a distinct listener device of a plurality of listener devices; wherein the poller transmitter is configured to generate a plurality of charging signals with a distinct charging signal transmitted to each of the plurality of antenna interface channels; and wherein each antenna interface channel is configured to be dynamically tuned independently of each other antenna interface channel of the plurality of antenna interface channels by adjusting an impedance of the respective antenna interface channel.

In some embodiments, each antenna interface channel includes a plurality of automatic antenna tuners, and wherein each automatic antenna tuner is configured to change impedance.

In some embodiments, the poller transmitter is configured to operate a first antenna interface channel separately from a second antenna interface channel.

In some embodiments, the plurality of antenna interface channels includes a first antenna interface channel and a second antenna interface channel, wherein the poller transmitter is configured to generate a first charging signal for the first antenna interface channel to generate a first output at a first RF output of the first antenna interface channel; wherein the poller transmitter is further configured to generate a second charging signal for the second antenna interface channel to generate a second output at a second RF output of the second antenna interface channel; wherein a first power of the first RF output is configured to be different than a second power of the second RF output.

In some embodiments, the poller transmitter is configured to establish an NFC link with each of the plurality of listener devices.

In some embodiments, the plurality of antenna interface channels comprises three or more antenna interface channels.

In some embodiments, the apparatus for wireless charging is incorporated into a semiconductor chip.

In accordance with some embodiments of the present disclosure, an example system for wireless charging is provided. The system may comprise: a battery; a poller transmitter electrically connected to the battery and electrically connected to a plurality of antenna interface channels, wherein each antenna interface channel is electrically connected to an associated poller antenna of a plurality of poller antennas; a plurality of poller antennas, wherein each of the plurality of poller antennas is electrically connected to a different one of the plurality of antenna interface channels; wherein the poller transmitter is configured to generate a plurality of charging signals with a distinct charging signal transmitted to each of the plurality of antenna interface channels; and wherein each antenna interface channel is configured to be dynamically tuned independently of each other antenna interface channel of the plurality of antenna interface channels by adjusting an impedance of the respective antenna interface channel.

In some embodiments, each antenna interface channel includes a plurality of automatic antenna tuners, and wherein each automatic antenna tuner is configured to change impedance.

In some embodiments, the poller transmitter is configured to operate a first antenna interface channel separately from a second antenna interface channel.

In some embodiments, the plurality of antenna interface channels includes a first antenna interface channel and a second antenna interface channel, wherein the poller transmitter is configured to generate a first charging signal for the first antenna interface channel to generate a first output at a first RF output of the first antenna interface channel; wherein the poller transmitter is further configured to generate a second charging signal for the second antenna interface channel to generate a second output at a second RF output of the second antenna interface channel; wherein a first power of the first RF output is configured to be different than a second power of the second RF output.

In some embodiments, the poller transmitter is configured to establish an NFC link with each of the plurality of listener devices.

In some embodiments, the plurality of antenna interface channels comprises three or more antenna interface channels.

In some embodiments, the plurality of listener devices are a pair of earbuds or hearing aids.

In accordance with some embodiments of the present disclosure, an example method is provided. The method may comprise: establishing a plurality of NFC links between a poller device and a plurality of listener devices, wherein the poller device comprises a poller transmitter electrically connected to a plurality of antenna interface channels, wherein each antenna interface channel is electrically connected to a respective one of a plurality of poller antennas, wherein each listener device is associated with one or the antenna interface channels and one poller antenna; determining which of the plurality of listener devices to be charged based on the plurality of NFC links; and charging at least one of the plurality of listener devices based on the determination of which of the plurality of listener devices to be charged, wherein charging the at least one listener device is via a first charging signal transmitted via a first antenna interface channel to a first poller antenna.

In some embodiments, each antenna interface channel includes a plurality of automatic antenna tuners, and wherein each automatic antenna tuner is configured to change impedance.

In some embodiments, the poller transmitter is configured to operate a first antenna interface channel separately from a second antenna interface channel.

In some embodiments, charging the at least one of the plurality of listener devices based on the determination of which of the plurality of listener devices to be charged comprises charging a first listener device at a first power and charging a second listener device at a second power.

In some embodiments the plurality of antenna interface channels comprises three or more antenna interface channels.

In some embodiments, the plurality of listener devices are a pair of earbuds or hearing aids.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates an exemplary block diagram of certain portions of a device with multiple channels in accordance with one or more embodiments of the present disclosure;

FIG. 2 illustrates exemplary circuitry and block diagram of a single antenna interface channel in accordance with one or more embodiments of the present disclosure;

FIG. 3 illustrates exemplary capacitor bank in accordance with one or more embodiments of the present disclosure;

FIG. 4 illustrates a flowchart that includes example operations for charging in accordance with one or more embodiments of the present disclosure;

FIG. 5 illustrates an exemplary graph of a charging profile in accordance with one or more embodiments of the present disclosure;

FIG. 6 illustrates an exemplary graph of current consumption versus matching impedance in accordance with one or more embodiments of the present disclosure; and

FIG. 7 illustrates an exemplary block diagram of a device in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

Various embodiments of the present disclosure are directed to improved wireless charging devices. Various embodiments may include dual-channel wireless charging devices that may be implemented on a single-chip.

The present disclosure provides an improved wireless charging (WLC) for near field communication (NFC) systems. WLC systems may include a poller device (e.g., earbud case) and one or more listener devices (earbuds, hearing aids, wearables, or hearing devices). The poller device may poll the one or more listener devices that listen for the polling and then respond. For example, WLC systems may include an earbud case (i.e., the poller or poller device) and the earbuds (i.e., listener devices) where WLC listener devices are related but independent, such as a pair of earbuds. Each of the poller device and the listener devices may have batteries that may need to be charged. The WLC charging charges the batteries of the listener devices wirelessly via an electromagnetic field generated by two or more antennas in the poller device. In the present disclosure, the batteries' levels of charge for the listener devices might be different. The current provided to respective antennas for wirelessly charging each listener devices may be different to address the different charge levels and/or other parameters of each listener device.

The present disclosure utilizes multiple channels for charging different listener devices. Each of the multiple channels may simultaneously and independently provide charging with different charging power levels, which may allow for charging of listener devices according to the current characteristics of the individual listener device(s) being charged. Each listener devices may be associated with a separate channel for charging in the poller device. For example, an apparatus may be a chip (e.g., an NFC chip) or circuit board that is configured with multiple channels for interfacing with multiple antennas. One channel and one associated antenna may be for each charging device. The apparatus may have at least two output ports, and each output port could configured for a differential output to an antenna. In a differential mode, the RF output ports could be set or adjusted to have distinct RF parameters, such as impedance and/or output power level. By independently setting such RF parameters each channel may be used to independently charge listener devices. This allows for the charging of two or more listener devices according to their own parameters. Additionally, or alternatively, adjusting the output power level of each channel independently may allow for reduction in power consumption of a poller device and thus save or prolong battery life and/or availability for future charging of listener devices without needing to recharge the battery of the poller device. The present disclosure also provides for improved battery life of the battery of a listener device. This is by only charging a listener device as needed and not overcharging the battery of a listener device.

Improvements are needed that address the characteristics and status of each device being charged. For example, some WLC-L devices are in pair, like the earbuds. The batteries' levels might be different, then the charging time and current might be different.

A poller device may dynamically charge a listener device by being configured as having different outputs of antenna interface channels. This may be a differential mode where the outputs of the antenna interface channels may be different, such as to accommodate different parameters. Alternatively, each antenna interface channel may be similarly configured, such as for at least for a period of time when both listener devices are charging. This period of time may be referred to as a time slot. In either configuration, the poller device may charge a plurality of listener devices simultaneously utilizing a plurality of antenna interface channels and an associated plurality of antennas.

In various embodiments, the poller device may regularly check with each listener device to determine if charging is still required. Once a listener device of no longer needs charging then poller device may turn off an antenna interface channel and thus stop charging one of the listener devices.

### Exemplary Systems, Apparatuses, and Methods

Embodiments of the present disclosure herein include systems, apparatuses, and methods for wirelessly charging listener devices utilizing multiple channels for wireless power delivery.

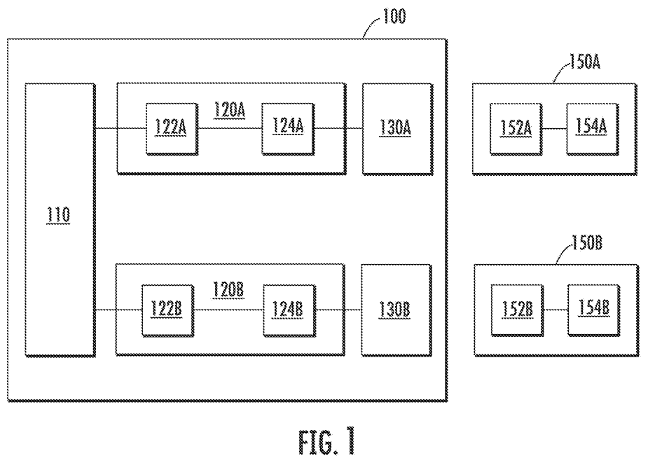

FIG. 1 illustrates an exemplary block diagram of certain portions of a device with multiple channels in accordance with one or more embodiments of the present disclosure. In various embodiments, a poller device 100 may include a plurality of antenna interface channels 120. A poller transmitter 110 of the poller device 100 may generate a plurality of charging signals with at least one for each of the antenna interface channels 120 to be used to charge the listener devices 150. An antenna 130 may be connected to an output of an antenna interface channel 120 via an RF output port located at the output of the antenna interface channel 120. An antenna interface channel 120 may comprise a filter 122A and a matching network 124A. The signals may be transmitted through each antenna interface channel 120 to a respective poller antenna 130 (e.g., 130A, 130B) of the poller device 100. As such, the poller transmitter may simultaneously, or separately, poll each of the poller antennas 130. It will be appreciated that while FIG. 1 illustrates one antenna interface channel 120, there may be more than two antenna interface channels 120.

In various embodiments, the poller device 100 may be a chip that could be incorporated into a larger system. Alternatively, the poller device 100 may be a system with multiple circuitries and/or components not located on one chip or circuit board. For example, in various embodiments, a system may include the poller transmitter 110 electrically connected to the antenna interface channels 120 that are each electrically connected to a respective poller antenna 130.

Each poller antenna 130 may generate an electromagnetic field to be received by a respective listener antenna 152 of a listener device 150. Similarly, the listener devices 150 may each generate a respective electromagnetic field to be received by the poller device 100. The poller device 100 and the listener devices 150 may communicate through the respective electromagnetic fields, including dynamically wirelessly charging each of the listener devices 150.

Dynamically wireless charging may include, among other things, turning on and/or off each antenna interface channel 120. This may include generating or creasing providing a signal to the respective poller antennas 130. In this manner the poller device 100 may choose which of the listener antennas 152 generate an electromagnetic field with and by dynamically controlling, generating, and/or adjusting the signal to an antenna interface channel 120 and/or tuning or adjusting the antenna interface channel 120 to dynamically change the power transmitted to each listener device.

Various embodiments may dynamically control power in multiple ways. For example, a poller transmitter 110 may switch on and/or off signals being provided to separate antenna interface channels 120 (e.g., 120A, 120B) and, thus, to poller antennas 130 (e.g., 130A, 130B). Additionally or alternatively, the poller device 100 may tune each of the antenna interface channels 120 by tuning, adjusting, and/or changing one or more portions of the antenna interface channels 120 as described herein.

For example, a first antenna interface channel 120A may receive a first signal from a poller transmitter 110 at half the power of a second signal to a second antenna interface channel 120B. This allows for a first listener device 150A to receive a greater amount of energy via a first electromagnetic field and to charge faster than a second listener device 150B. The plurality of antenna interface channels 120 may allow for dynamic control by tuning, adjusting, or ceasing the providing of respective signals to antennas 130 for the listener devices 150.

In various embodiments, a poller device 100 may utilize a static mode and/or a negotiated mode.

In a static mode, the poller device 100 may provide power at a single power level. For example, a signal may be provided to an antenna interface channel 120 as either on or off at a single voltage.

In a negotiated mode, the poller device may negotiate with each listener device 150 as to the power level to be delivered to the respective listener device 150. Each listener device 150 may have a different charge level for its listener battery 154 and the charging for the respective listener devices 150 may be dynamic and specific to the listener devices 150. Each listener device 150 may thus be independently charged. A negotiated power level may be based on a charging profile and/or one or more signals received from the listener device 150. A charging profile may be based on, for example, a charging curve for charging the battery of a listener device 150. This may, among other things, avoid over-charging, which also benefits the poller device's 100 battery. For example, it may benefit the battery life of the poller device's 100 battery. It also may save the poller devices 100 power consumption. A signal from the listener device 150 may provide or be used by the poller device 100 to determine the current charge of a battery 154 of a listener device 150. Thus the poller device 100 may determine how much power to provide via the antenna 130, such as based on a charging profile.

This includes that one listener device 150 (e.g., 150A) may be charged through an associated poller antenna 130 (e.g., 130A) while other listener devices 150 (e.g., 150B) are not charged. For example, users may only use one earbud at a time and thus deplete the earbud's (e.g., listener device's 150) battery charge while the other earbud's battery is fully charged.

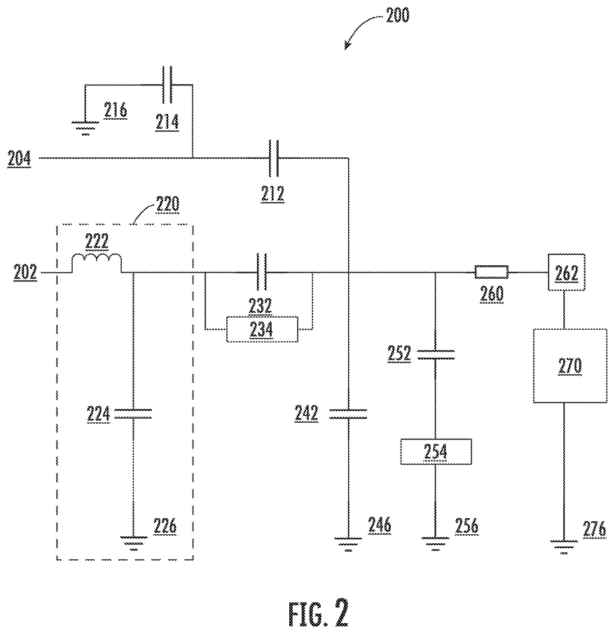

FIG. 2 illustrates exemplary circuitry and block diagram of a single antenna interface channel in accordance with one or more embodiments of the present disclosure. This may include an antenna interface channel 200 and a poller antenna 270. This illustrates a single-ended antenna configuration. The antenna interface channel 220 is an example of the plurality of antenna interface channels 120. An antenna interface channel 200 may include ports (e.g., 202, 204) to receive a signal from a poller transmitter 110. In various embodiments, the port 202 may be an input port to transmit signals to the listener device 150 and the port 204 may be an output port that receives signals transmitted back from the listener device 150. The antenna interface channel 200 may include a filter 220. The antenna interface channel 200 may include a plurality of capacitors (e.g., 212, 214, 232, 242, 252), resistors (e.g., 260), inductors, automatic antenna tuner (e.g., 234) and/or and voltage control capacitor banks (e.g., 254). In various embodiments, the automatic antenna tuner 234 illustrated may alternatively be a capacitor bank or a voltage control capacitor. The plurality of capacitors, resistors, and/or inductors may be used to set an impedance of the antenna interface channel 200, which may be adjusted as described herein. The antenna interface channel 200 may include an RF output 262 that may be electrically connected to the poller antenna 270.

In various embodiments, the filter 220 may be a low pass filter comprised of an inductor 222 and a capacitor 224 with the capacitor grounded with a ground 226. A low pass filter may remove high frequencies above a threshold. Changing a capacitance and/or impedance of the low pass filter may tune the threshold below which frequencies may be passed. Additionally or alternatively, the filter 220 may be comprised of additional filters (e.g., a second filter) and/or alternative filters (e.g., high pass, bandwidth, etc.). In various embodiments, the filter 220 may be configured for impedance matching, or not matching, to match the impedance of one or more other portions of circuitry, such as the impedance at the RF output 262 and/or the antenna 270. For example, in various embodiments, a voltage control capacitor or capacitor bank may be added in parallel with capacitor 224 to allow for dynamic tuning and/or adjustment of the impedance of the filter 220. This may allow for adjusting impedance for impedance matching. The poller device 100 may dynamically tune and/or adjust such impedances similar to analogous operations of tuning and/or adjusting other impedances described herein.

The power delivered by an antenna interface channel 200 may be tuned, adjusted, changed, and/or varied by changing the impedance of the antenna interface channel 200. Tuning the impedance may be performed during one or more operations by changing the capacitance and/or impedance and/or controlling the signal provided to each antenna interface channel 200.

A first automatic antenna tuner 234 and/or second automatic antenna tuner 254 may be comprised of a voltage-controlled capacitors and/or capacitor banks, each of which may be tuned based on one or more selection signals generated by the poller device 100, such as by the poller transmitter 110. Each automatic antenna tuner may be controlled to adjust the output power level transmitted through one or more antennas 270 of a poller device 100 to associated listener devices 150, such as according to one or more charging profiles. For example, the first automatic antenna tuner 234 may be comprised of a one or more voltage-controlled capacitors that may be controlled by application of a voltage signal that varies the capacitance of automatic antenna tuner 234. A first selection signal associated with the first automatic antenna tuner 234 may be received by the first automatic antenna tuner 234 to tune its capacitance. The second automatic antenna tuner 254 may be comprised of a capacitor bank of comprised of plurality of capacitors in parallel that may be connected or disconnected via selection switches controlled by an associated second selection signal. Thus each of the first automatic antenna tuner 234 and/or second automatic antenna tuner 254 may be controlled by, respectively, a first selection signal and a second selection signal that may be provided to the antenna interface channel 200, such as from a poller transmitter 110 and/or a processor.

By tuning the impedance of the antenna interface channel 200 the matching of the impedance of the antenna 270 may be varied, such as by multiples. In various embodiments the automatic antenna tuner (e.g., 234, 254) may be used to determine a best impedance matching to get a maximum amplitude of a carrier frequency signal or a best phase of the carrier frequency signal. Dynamically changing the impedance allows for the RF matching for each antenna interface channel 200 to implement dynamic output power control for each of the plurality of antenna interface channels 120 for wireless charging. The current consumption of the poller device 100 is inversely proportional to antenna matching impedance and, thus a higher impedance is associated with lower power delivery.

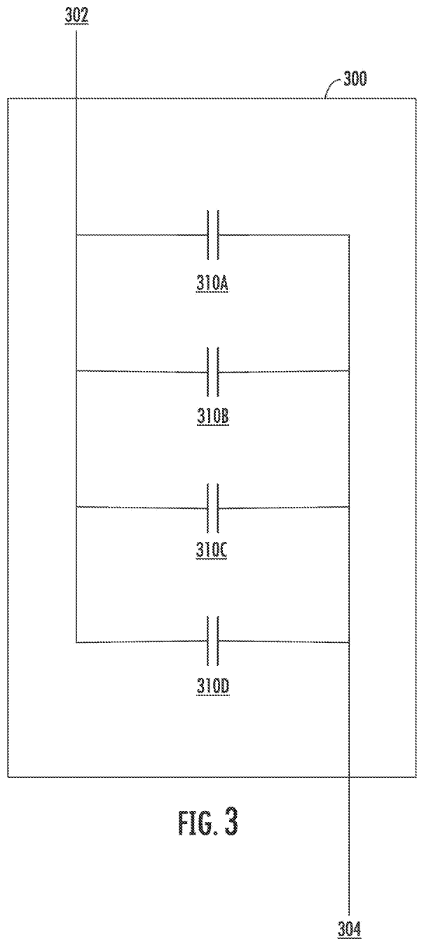

FIG. 3 illustrates exemplary capacitor bank in accordance with one or more embodiments of the present disclosure. The capacitor bank 300 may include a first terminal 302 and a second terminal 304 as well as a plurality of capacitors 310. There may additionally be a plurality of switches, such as one switch for each of the plurality of capacitors 310. A selection signal provided to the capacitor bank 300 may control the plurality of switches 310 to connect or disconnect one or more of the capacitors 310. By switching on and/or off capacitors the impedance may be controlled by adding or removing capacitance from the circuit. In various embodiments, a capacitor bank 300 may be used for a first automatic antenna tuner 234 and/or second automatic antenna tuner 254.

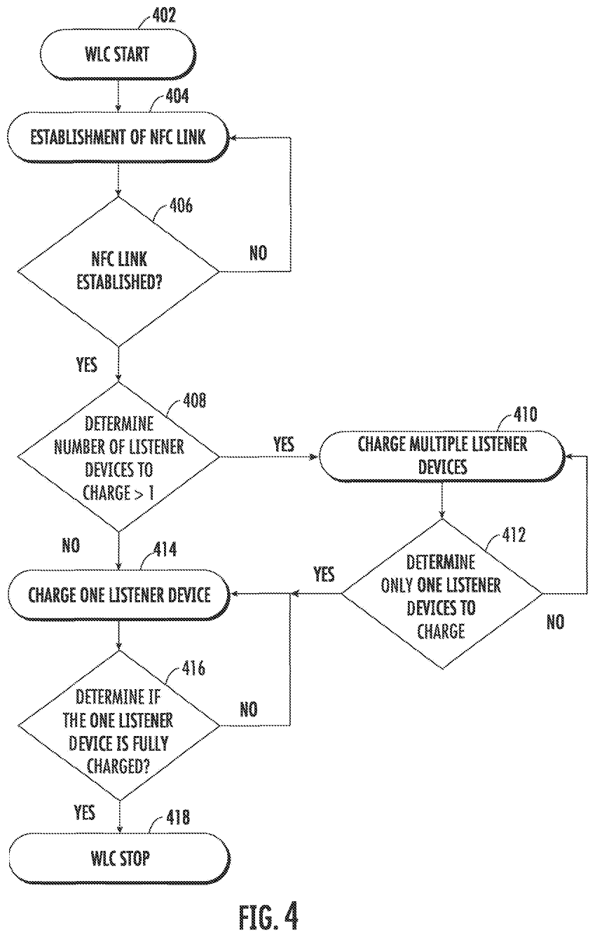

FIG. 4 illustrates a flowchart that includes example operations for charging in accordance with one or more embodiments of the present disclosure.

At operation 402, wireless charging starts. The start of wireless charging includes one or more of the following operations. The start of wireless charging may occur based on a trigger or signal. Such a trigger or signal may be generated by a sensor of the poller device 100. In various embodiments (e.g., of an earbud case with space to contain earbuds), an electrical sensor or magnetic sensor may determine when a lid of the poller device 100 is closed, and such sensors may generate a signal that is used by the poller device 100 to start the wireless charging.

At operation 404, establishment of an NFC link. The poller device 100 attempts to establish of an NFC link with each listener device 150 to determine how many listener devices 150 are present and how many need to be charged. An NFC link between the poller device 100 and each listener device 150 may allow for data identifying the listener device 150 and/or state of charge to be transmitted to the poller device 100.

At operation 406, determine if an NFC link has been established. If an NFC link is not established, then operation 404 may be repeated. Alternatively, if an NFC is established then may proceed to operation 408.

At operation 408, determines the number of listener devices to charge is greater than 1. If the number of listener devices 150 to charge is greater than 1, then may proceed to operation 410. If the number of listener devices 150 to charge is not greater than 1, then may proceed to operation 414.

At operation 410, multiple listener devices are charged. When multiple listener devices 150 are detected via NFC links being established, charging of each of the multiple listener devices 150 is performed. To charge a listener device 150, the poller device 100 uses or turns on a respective antenna interface channel 120 to provide power to a respective poller antenna 130. Thus each poller antenna 130 may generate an electromagnetic field that will be provided to respective listener device 150, specifically an associated antenna of the listener device 150. As the listener device 150 is charged, the poller device 100 may determine if a device is fully charged to stop provided charging, such as by turning off an associated antenna interface channel 120.

Additionally or alternatively, an antenna interface channel 120 associated with a listener device 150 may be tuned or adjusted to adjust the amount of power being provided for charging the listener device 150. The tuning and/or adjustment may be with one or more antenna interface channels 120 and may be according to a charging profile. For example, each antenna interface channel 120 may have its voltage independently controlled, current independently controlled, or both voltage and current independently controlled. Additionally or alternatively, the impedance of each antenna interface channel 120 may be independently controlled. With such independent controls, each antenna interface channel 120 may independently charge a respective listener device. In various embodiments, the multiple antenna interface channels 120 may be used to switch on and off the associated antennas 130 to dynamically and simultaneously provide wireless charging to the multiple listener devices. Additionally or alternatively, the antenna interface channels 120 may each be tuned and/or adjusted based on a negotiated mode where the listener device(s) 150 may transmit one or more signals to the poller device 100 that is used to control tuning and/or adjustments to the respective antenna interface channel.

In various embodiments, the charging of one or more listener devices 150 may occur according to a charging profile or characteristics of the individual listener devices 150. The poller device 100 may separately poll each listener device 150 to request information and/or data about the respective listener device 150. In response to such polling, the poller device 100 may received information and/or data from the respective listener devices 150 providing, among other things, a power level, current charge level, or the like. The poller device 100 may poll the listener devices regularly and control each of the power transmissions to each of the listener devices 150 independently and dynamically according to a charging profile of each respective listener device 150. Dynamic control may include controlling the voltage, current, and/or impedance to one or more of the antenna interface channels 120, which may each be controlled separately. The charging of multiple listener devices 150 may occur until only one listener device 150 remains to be charged.

For example, there may be two listener device 150 requiring charging from a poller device 100. The first listener device 150A may be associated with a first antenna interface channel 120A and the second listener device 150B may be associated with a second antenna interface channel 120B. The poller device 100 may independently control the first antenna interface channel 120A by controlling for voltage, current, and/or impedance to charge the first listener device 150A according to a first charging profile associated with the first listener device 150A. The poller device 100 may also independently control the second antenna interface channel 120B by controlling for voltage, current, and/or impedance to charge the second listener device 150B according to a second charging profile associated with the second listener device 150B. Thus the poller device 100 may independently change the output power of each antenna interface channel 120 to control the charging of the respective listener devices 150.

The independent control of one or more antenna interface channels 120 by the poller device 100 may occur regularly, such as at various time intervals. For example, the poller device 100 may poll one or more listener devices 150 according to a first time period. As another example with two or more listener devices 150, the poller device 100 may poll each of the respective listener devices 150 at different time periods. Thus the poller device 100 may check the power requirements of the various listener devices 150.

Once one or more of the listener devices 150 (e.g., 150A) are determined to be charged such that they no longer need as much power, the poller device 100 may reduce the voltage, reduce the current, or increase the impedance of the antenna interface channel 120 associated with that listener device 150 (e.g., 150). If one or more listener device 150 (e.g., 150B) are determined to be charged such that they need increased or more charging, the poller device 100 may increase the voltage, increase the current, or reduce the impedance of the antenna interface channel 120 associated with that listener device 150 (e.g., 150). Such independent and dynamic controlling of such independent antenna interface channels 120 may be performed periodically.

At operation 412, determine only one listener devices is to be charged. The poller device 100 may regularly check the progress of the charging of the listener devices 150 and tune the respective antenna interface channels 120 accordingly. As the multiple listener devices 150 are charged, one or more of the listener devices may reach full charge faster. This may occur until only one listener device 150 remains to be charged. The poller device 100 continues to receive listener devices information and/or data via the NFC link and will determine once only one listener device 150 remains to be charged. If more than one listener device 150 continues to need charge, the poller device 100 will continue with operation 410. If only one listener device 150 is to be charged then proceed to operation 414. Additionally or alternatively, all of the antenna interface channels 120 and associated antennas 130 associated with listener devices 150 no longer being charged may be turned off and/or have signals to those antenna interface channels 120 cease being provided.

At operation 414, one listener device is charged. For the one listener device 150 to be charged, the poller device 100 may turn on an associated antenna interface channel 120 to provide a signal to energize an associated antenna 130 to generate an electromagnetic field that will be received by an antenna associated with the listener device 150 to charge the listener device 150. The poller device 100 may charge the listener device 150 according to a charging profile, which may include tuning and/or adjusting the voltage, current, or impedance of the antenna interface channel 130, such as described herein.

At operation 416, determine if the one listener device is fully charged. The poller device 100 may regularly check the progress of the charging of the one listener device 150 and tune the respective antenna interface channel 120 accordingly. The poller device 100 may determine if the one listener device 150 is fully charged via the NFC link. If the one listener device 150 is not charged, the poller device 100 may continue charging the listener device 150. If the one listener device 150 is fully charged then the poller device 100 may stop charging the one listener device and stop wireless charging.

At operation 418, wireless charging stops.

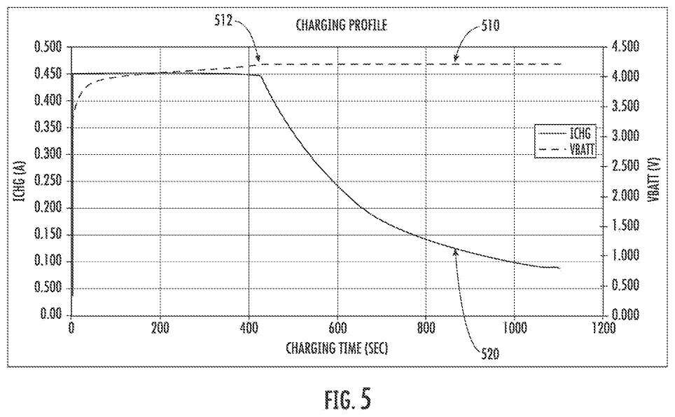

FIG. 5 illustrates an exemplary graph of a charging profile in accordance with one or more embodiments of the present disclosure. The charging profile illustrated in FIG. 5 includes a first curve 510 of the battery voltage of an exemplary listener device 150 that is being charged from empty to full charge. The charging profile illustrated in FIG. 5 also includes a second battery charging curve 520. The charging profile illustrates how when the battery voltage is greater than a first level 512 then the battery's voltage 510 will be flat and the charging current 520 may drop significantly, such as during charging. Thus a wireless charger may provide the same power level to the listener device 150 but the current from the battery of the poller device 100 may be reduced and, thus, there is a reduction the power of the poller device 100. This reduction allows for a better charging efficiency when otherwise there would be a waste in power from the poller device 100. In view of the power consumption and charging efficiency of the present disclosure, the poller device 100 may reduce the output power level by reducing the current to an antenna (e.g., 270) step by step to meet with the charging profile of a listener device 150. This may save power for the poller device 100. The adjustment in the power level may be performed by adjusting the impedance matching of the antenna (e.g., 270) of the poller device 100.

As illustrated, as the charging current is at a first level 512 (e.g., 0.45 A) to the antenna interface channel 120 until the battery of the listener device 150 is charge to a first level 512. The first level 512 may be a first threshold (e.g., 90%) where the battery of the listener device 150 may be considered fully charged or sufficiently charged to drop the charging current provided to the associated poller antenna 130 and, thus, reduce the power in the electromagnetic field being produced by the poller antenna 130. In various embodiments, other charging profiles may include additional thresholds, (e.g., 50%, 75%, 90%) that may be used in a negotiated mode to determine an amount of power to provide to a poller antenna 130 via an associate antenna interface channel 120.

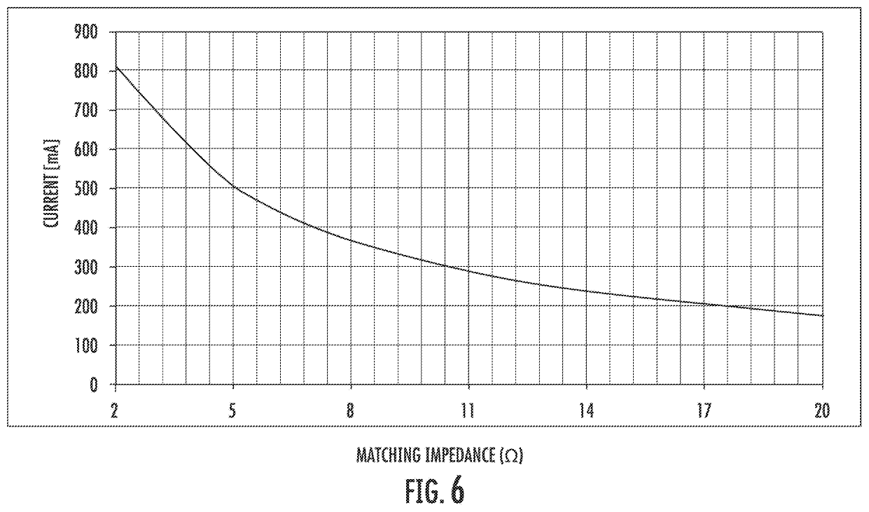

FIG. 6 illustrates an exemplary graph of current consumption versus matching impedance in accordance with one or more embodiments of the present disclosure. As illustrated, the current consumption decreases as the amount of impedance matching increases, which is an increase in the impedance of an antenna interface channel 120. The poller device 100 current consumption is inversely proportional to antenna interface channel 120 matching impedance with a higher impedance associated with a lower power delivery. By tuning and/or adjusting the impedance of an antenna interface channel 120 the power to the associated poller antenna 130 may be controlled to tune or adjust the amount of wireless charging being provided. By tuning and/or adjusting each antenna interface channel 120 separately the poller device 100 may dynamically and simultaneously control the wireless charging of the multiple listener devices 150.

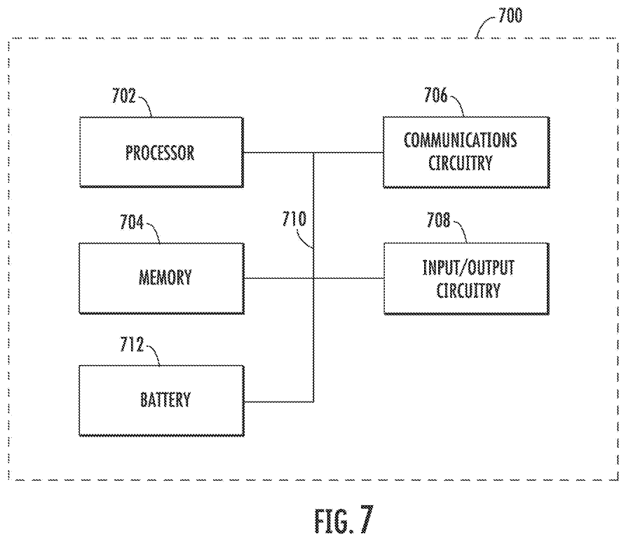

FIG. 7 illustrates an exemplary block diagram of a device in accordance with one or more embodiments of the present disclosure. Various embodiments may have the device 700 be a poller device 100 or a listener device 150. The device 700 illustrated may be a system and/or apparatus that includes a processor 702, memory 704, communications circuitry 706, input/output circuitry 708, battery 712, and all of which may be connected by a bus 710. While such connections are illustrated as bus 710, it will be readily appreciated that there may be multiple other connections.

The processor 702, although illustrated as a single block, may be comprised of a plurality of components and/or processor circuitry. The processor 702 may be implemented as, for example, various components comprising one or a plurality of microprocessors with accompanying digital signal processors; one or a plurality of processors without accompanying digital signal processors; one or a plurality of coprocessors; one or a plurality of multi-core processors; processing circuits; and various other processing elements. The processor may include integrated circuits. In various embodiments, the processor 702 may be configured to execute applications, instructions, and/or programs stored in the processor 702, memory 704, or otherwise accessible to the processor 702. When executed by the processor 702, these applications, instructions, and/or programs may enable the execution of one or a plurality of the operations and/or functions described herein. Regardless of whether it is configured by hardware, firmware/software methods, or a combination thereof, the processor 702 may comprise entities capable of executing operations and/or functions according to the embodiments of the present disclosure when correspondingly configured.

The memory 704 may comprise, for example, a volatile memory, a non-volatile memory, or a certain combination thereof. Although illustrated as a single block, the memory 704 may comprise a plurality of memory components. In various embodiments, the memory 704 may comprise, for example, a random access memory, a cache memory, a flash memory, a hard disk, a circuit configured to store information, or a combination thereof. The memory 704 may be configured to write or store data, information, application programs, instructions, etc. so that the processor 702 may execute various operations and/or functions according to the embodiments of the present disclosure. For example, in at least some embodiments, a memory 704 may be configured to buffer or cache data for processing by the processor 702. Additionally or alternatively, in at least some embodiments, the memory 704 may be configured to store program instructions for execution by the processor 702. The memory 704 may store information in the form of static and/or dynamic information. When the operations and/or functions are executed, the stored information may be stored and/or used by the processor 702.

The communication circuitry 706 may be implemented as a circuit, hardware, computer program product, or a combination thereof, which is configured to receive and/or transmit data from/to another component or apparatus. The computer program product may comprise computer-readable program instructions stored on a computer-readable medium (e.g., memory 704) and executed by a processor 702. In various embodiments, the communication circuitry 706 (as with other components discussed herein) may be at least partially implemented as part of the processor 702 or otherwise controlled by the processor 702. The communication circuitry 706 may communicate with the processor 702, for example, through a bus 710. Such a bus 710 may connect to the processor 702, and it may also connect to one or more other components of the processor 702. The communication circuitry 706 may be comprised of, for example, transmitters, receivers, transceivers, network interface cards and/or supporting hardware and/or firmware/software, and may be used for establishing communication with another component(s), apparatus(es), and/or system(s). The communication circuitry 706 may be configured to receive and/or transmit data that may be stored by, for example, the memory 704 by using one or more protocols that can be used for communication between components, apparatuses, and/or systems.

In various embodiments, the communication circuitry 706 may include the poller transmitter 110, antenna interface channels 120, and the antenna 130. The communications circuitry 706 may be operated to establish NFC links with a plurality of listener devices 150 and/or to wirelessly charge the plurality of listener devices 150.

The input/output circuitry 708 may communicate with the processor 702 to receive instructions input by an operator and/or to provide audible, visual, mechanical, or other outputs to an operator. The input/output circuitry 708 may comprise supporting devices, such as a keyboard, a mouse, a user interface, a display, a touch screen display, lights (e.g., warning lights), indicators, speakers, and/or other input/output mechanisms. The input/output circuitry 708 may comprise one or more interfaces to which supporting devices may be connected. In various embodiments, aspects of the input/output circuitry 708 may be implemented on a device used by the operator to communicate with the processor 702. The input/output circuitry 708 may communicate with the memory 704, the communication circuitry 706, and/or any other component, for example, through a bus 710.

In various embodiments, a battery 712 may provide power to the device 700. In various embodiments, the battery 712 may also be used to provide power to one or more poller antennas 130 that may generate electromagnetic fields to charge the batteries of listener devices 150.

It should be readily appreciated that the embodiments of the systems, apparatuses, and methods described herein may be configured in various additional and alternative manners in addition to those expressly described herein.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. An apparatus for wireless charging comprising:
a poller transmitter electrically connected to a plurality of antenna interface channels, wherein each antenna interface channel includes an output port for connection to a poller antenna of a plurality of poller antennas for wirelessly charging a distinct listener device of a plurality of listener devices;
wherein the poller transmitter is configured to generate a plurality of charging signals with a distinct charging signal transmitted to each of the plurality of antenna interface channels; and
wherein each antenna interface channel is configured to be dynamically tuned independently of each other antenna interface channel of the plurality of antenna interface channels by adjusting an impedance of the respective antenna interface channel.

2. The apparatus for wireless charging of claim 1, wherein each antenna interface channel includes a plurality of automatic antenna tuners, and wherein each automatic antenna tuner is configured to change impedance.

3. The apparatus for wireless charging of claim 1, wherein the poller transmitter is configured to operate a first antenna interface channel separately from a second antenna interface channel.

4. The apparatus for wireless charging of claim 1, wherein the plurality of antenna interface channels includes a first antenna interface channel and a second antenna interface channel, wherein the poller transmitter is configured to generate a first charging signal for the first antenna interface channel to generate a first output at a first RF output of the first antenna interface channel; wherein the poller transmitter is further configured to generate a second charging signal for the second antenna interface channel to generate a second output at a second RF output of the second antenna interface channel; wherein a first power of the first RF output is configured to be different than a second power of the second RF output.

5. The apparatus for wireless charging of claim 1, wherein the poller transmitter is configured to establish an NFC link with each of the plurality of listener devices.

6. The apparatus for wireless charging of claim 5, wherein the plurality of antenna interface channels comprises three or more antenna interface channels.

7. The apparatus for wireless charging of claim 1, wherein the apparatus for wireless charging is incorporated into a semiconductor chip.

8. A system for wireless charging comprising:
battery;
a poller transmitter electrically connected to the battery and electrically connected to a plurality of antenna interface channels, wherein each antenna interface channel is electrically connected to an associated poller antenna of a plurality of poller antennas;
a plurality of poller antennas, wherein each of the plurality of poller antennas is electrically connected to a different one of the plurality of antenna interface channels;
wherein the poller transmitter is configured to generate a plurality of charging signals with a distinct charging signal transmitted to each of the plurality of antenna interface channels; and
wherein each antenna interface channel is configured to be dynamically tuned independently of each other antenna interface channel of the plurality of antenna interface channels by adjusting an impedance of the respective antenna interface channel.

9. The system for wireless charging of claim 8, each antenna interface channel includes a plurality of automatic antenna tuners, and wherein each automatic antenna tuner is configured to change impedance.

10. The system for wireless charging of claim 8, wherein the poller transmitter is configured to operate a first antenna interface channel separately from a second antenna interface channel.

11. The system for wireless charging of claim 8, wherein the plurality of antenna interface channels includes a first antenna interface channel and a second antenna interface channel, wherein the poller transmitter is configured to generate a first charging signal for the first antenna interface channel to generate a first output at a first RF output of the first antenna interface channel; wherein the poller transmitter is further configured to generate a second charging signal for the second antenna interface channel to generate a second output at a second RF output of the second antenna interface channel; wherein a first power of the first RF output is configured to be different than a second power of the second RF output.

12. The system for wireless charging of claim 8, wherein the poller transmitter is configured to establish an NFC link with each of the plurality of listener devices.

13. The system for wireless charging of claim 12, wherein the plurality of antenna interface channels comprises three or more antenna interface channels.

14. The system for wireless charging of claim 8, wherein the plurality of listener devices are a pair of earbuds or hearing aids.

15. A method comprising:
establishing a plurality of NFC links between a poller device and a plurality of listener devices, wherein the poller device comprises a poller transmitter electrically connected to a plurality of antenna interface channels, wherein each antenna interface channel is electrically connected to a respective one of a plurality of poller antennas, wherein each listener device is associated with one or the antenna interface channels and one poller antenna;
determining which of the plurality of listener devices to be charged based on the plurality of NFC links; and
charging at least one of the plurality of listener devices based on the determination of which of the plurality of listener devices to be charged, wherein charging the at least one listener device is via a first charging signal transmitted via a first antenna interface channel to a first poller antenna.

16. The method of claim 15, wherein each antenna interface channel includes a plurality of automatic antenna tuners, and wherein each automatic antenna tuner is configured to change impedance.

17. The method of claim 15, wherein the poller transmitter is configured to operate a first antenna interface channel separately from a second antenna interface channel.

18. The method of claim 15, wherein charging the at least one of the plurality of listener devices based on the determination of which of the plurality of listener devices to be charged comprises charging a first listener device at a first power and charging a second listener device at a second power.

19. The method of claim 15, wherein the plurality of antenna interface channels comprises three or more antenna interface channels.

20. The method of claim 15, wherein the plurality of listener devices are a pair of earbuds or hearing aids.
